(19) United States
(12) Patent Application Publication
(10) Pub. No.: US 2026/0326738 A1
(43) Pub. Date: Oct. 22, 2026

(54) HIGH SPEED AIR-CUSHIONED VEHICLE

(71) Applicant: CHINOOK HIGH SPEED RAIL TRANSIT CORP, Alberta (CA)

(72) Inventor: Callum Hanton, Alberta (CA)

(73) Assignee: CHINOOK HIGH SPEED RAIL TRANSIT CORP, Alberta (CA)

(21) Appl. No.: 19/110,414

(22) PCT Filed: Sep. 11, 2023
(86) PCT No.: PCT/CA2023/051204

§ 371 Date: Mar. 10, 2025

(51) Int. Cl. B60V 1/14

(52) U.S. Cl. CPC B60V 1/14

(57) ABSTRACT

A cargo or passenger vehicle floats on a cushion of air, which is generated initially by electrically driven compressors, and having a forward propulsion engine such as a linear induction motor or jet engine. As forward velocity increases, the body of the vehicle helps to turn drag force into compressed air, which is heated by waste heat from the forward propulsion engine, and used by the compressor system to create the air cushion.

### FIELD OF THE INVENTION

The present invention relates to a vehicle employing an air cushioning system.

### BACKGROUND OF THE INVENTION

Rapidly declining transit and industrial infrastructure, as well as an ever growing focus on sustainability and energy efficiency has led to desire for a more efficient and rapidly moving way to move large amounts of people and industrial goods. While magnetic levitation vehicles, traditional rail, and even hyperloops have been explored, none offer an attractive ease and cost of construction and desired speed.

Hovercraft vehicles which ride on a cushion of air have been developed but can only be used in specialized niche applications, and are unsuitable for general mass transportation. While tracked air cushion trains have been explored, the inefficiency of cushion generation and noise have made them unattractive alternatives.

There is a need in the art for a more efficient system for providing a vehicle with an air cushion.

### SUMMARY OF THE INVENTION

In one aspect, in general terms, the present invention comprises an air cushion system for a vehicle, the vehicle comprising a chassis and a forward propulsion engine, the system comprising:
a) an air intake located in a high pressure zone created by forward movement of the vehicle;
b) an air cushion compressor; and
c) a heat exchanger associated with the forward propulsion engine, disposed between the air intake and the air cushion compressor, to heat the air prior to being compressed by the air cushion compressor.

In another aspect, the invention comprises a method of forming an air cushion under a high-speed vehicle, comprising the steps of:
a) drawing in air from an air intake located in a high pressure zone created by forward movement of the vehicle;
b) heating the air with heat from a forward propulsion engine and passing the air to an air cushion compressor; and
c) forming an air cushion with the air cushion compressor.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

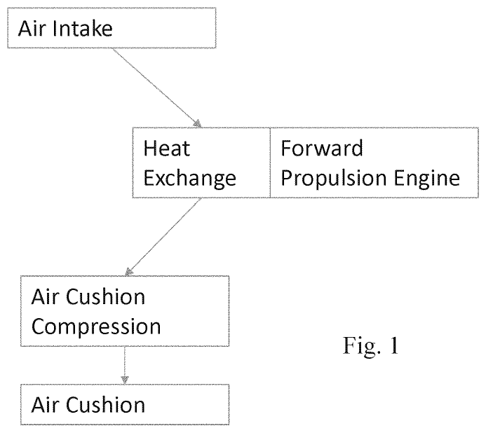

a) FIG. 1 is a schematic flowchart showing the basic principle of operation of one aspect of the present invention.

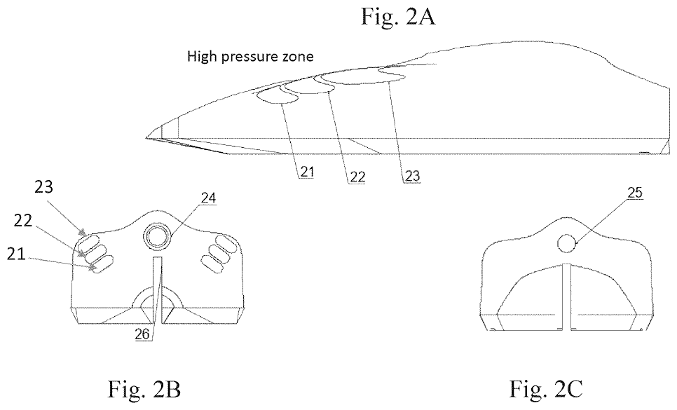

b) FIGS. 2A-C shows side, front and rear plan views (respectively) of one embodiment of a vehicle comprising the present invention.

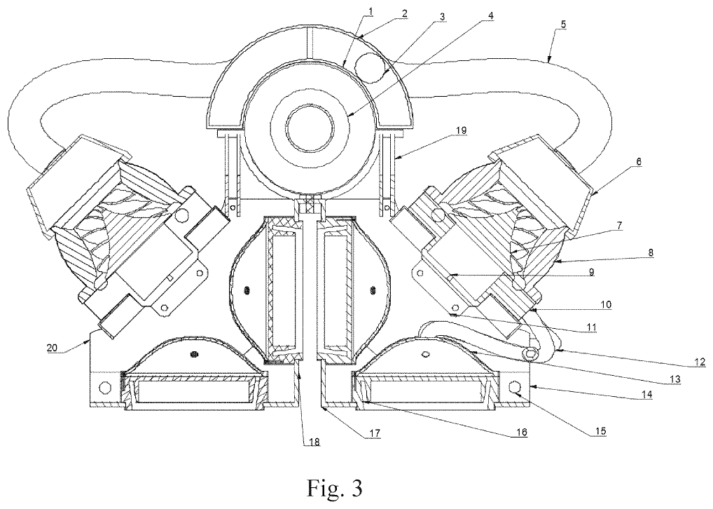

c) FIG. 3 is a cutaway view of a lateral cross-section of the vehicle shown in FIG. 2.

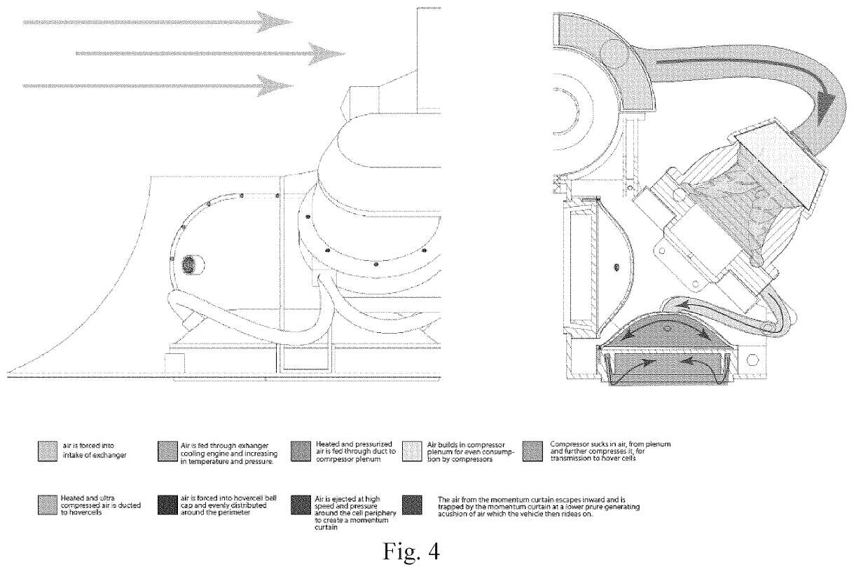

d) FIG. 4 is a schematic diagram of air flow through the compression and hover cell system. The left half is a side view while the right half is a lateral cross-sectional view.

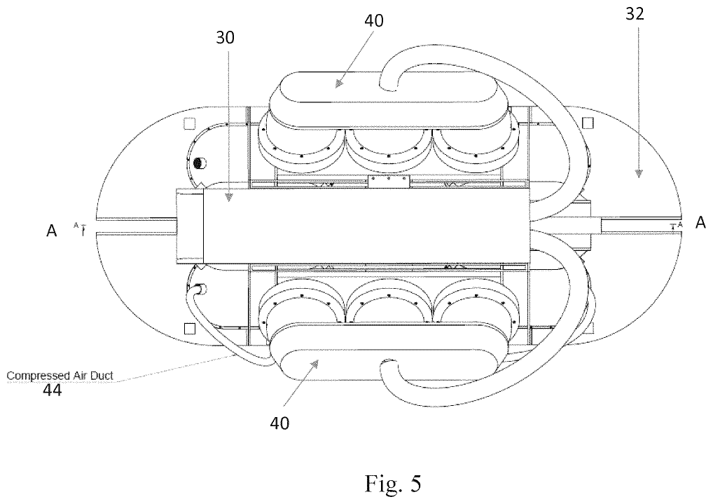

e) FIG. 5 is a top plan view of an alternative embodiment, having a linear induction motor.

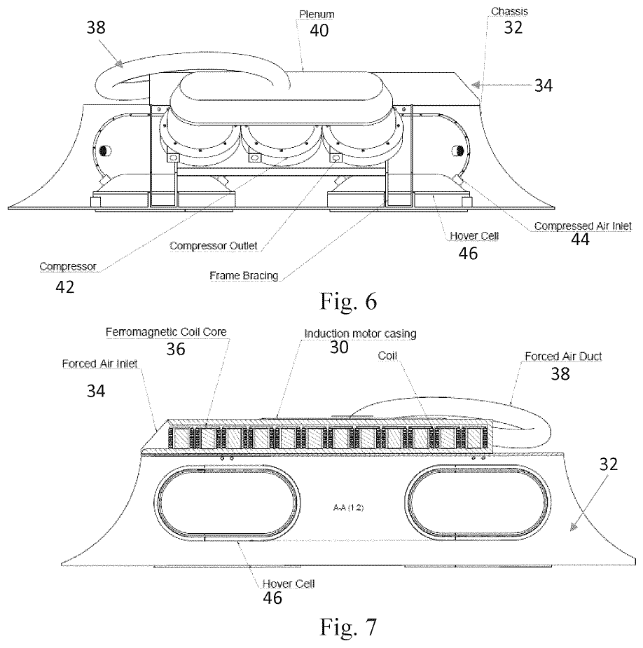

f) FIG. 6 is a side view of the embodiment of FIG. 5.

g) FIG. 7 is a cross-sectional view along line A-A of FIG. 5

### DETAILED DESCRIPTION OF EMBODIMENTS OF THE INVENTION

In general terms, the invention comprises a vehicle configured to be propelled at high speeds, for example greater than 200 km/h, and preferably greater than 300 km/h, and at least partially riding on an air cushion. Preferably, the vehicle rides entirely on an air cushion. The vehicle may be free-moving, or may be constrained such as with a rail, track or guiderails.

The air cushioning system comprises a high pressure air intake which is coupled with the forward propulsion engine, in the manner described below.

The air cushion, as known to those skilled in the art, will lower the loss of efficiency to friction by virtually eliminating rolling resistance to forward momentum. The air cushion is maintained by diverting air from a zone of high pressure created in front of the vehicle moving at high speed, and heating and pressurizing the air with waste heat from a forward propulsion engine. This configuration has the ancillary benefit of reducing aerodynamic resistance to forward momentum.

FIGS. 2A-C shows one embodiment of a vehicle. The vehicle is generally aerodynamically shaped as it is intended to travel at high velocities. In one embodiment, the forward propulsion engine is a jet engine, such as a turbofan engine commonly used on passenger aircraft. Compression air intakes 21, 22, 23 in the nose of the vehicle are located in a zone which experiences high air pressure when the vehicle is moving at high speed. The jet engine intake 24 is centrally positioned, as is the jet engine exhaust 25.

The compression air inlets may variable in size. In one example, the inlet may be covered with adjustable louvers, or with an adjustable covering which varies the size of the opening.

One embodiment of the invention is shown in cutaway view in FIG. 3. The vehicle is a track-guided rail vehicle, intended to be entirely air supported when in forward motion. A jet engine 4, which is the forward propulsion engine, is centrally positioned in the vehicle chassis 17, 18 and supported by an engine cradle 19. The jet engine is surrounded by heat exchanger 1 which is covered by exchanger shroud 2. The chassis is bolted together with structural bolts 15 and retaining clamps 14.

In other embodiments, the forward propulsion engine may be a linear induction motor or other propulsion system which does not required ground contact. If electric power is required, electric energy may be supplied by any suitable source, such as an on-board generator (not shown) which may be powered by an internal combustion engine or a gas turbine engine, from a battery system (not shown), or from an external power source such as a “third” rail or overhead power line, or by a wireless power transmitter (not shown).

Air entering the compression inlets 21, 22, 23 is directed into the heat exchanger 1, where it is heated with heat generated by the forward propulsion engine, which preferably is heat that must be removed in any event. The heated air passes into the heat exchanger outlet 3 and into the compressor duct 5, leading to the air cushion compressor intake plenum 6.

In this embodiment, the air cushion compressor comprises a centrifugal fan 7 positioned within a compressor shroud 8, supported by a base member 10 and support bracket 11. The compressor may driven by any suitable motor or engine, such as an electric motor 9. Electric energy may be supplied by on-board generator (not shown), from a battery system (not shown), or from an external power source such as a “third” rail or overhead power line, or by a wireless power transmitter (not shown). In other embodiments, the compressor may be driven by a gas turbine engine.

Gay-Lussac's law states that the pressure of a given mass of gas varies directly with the absolute temperature of the gas when the volume is kept constant. Thus, the air, when heated in an enclosed space, will experience a pressure increase. As the air compressor 7 creates a lower pressure zone in its intake, creating suction resistance, the supply of heated air from the heat exchanger will reduce the suction resistance at low speeds due to its increased pressure, allowing the creation of the required air cushion with lower energy expenditure. As speed increases, the air pressure from the inlets and the heat exchanger will increase accordingly, further reducing the energy expenditure required for the air cushion.

Furthermore, the vehicle may be aerodynamically shaped to create a high-pressure zone in the vicinity of the air inlets. Ordinarily, this high pressure zone would add to unwanted aerodynamic resistance experienced by the vehicle, however, by providing the air inlets in this zone, the aerodynamic resistance is reduced.

The compressor 7 output is directed into conduit 12 and into a bell-shaped hover plenum 13. The plenum is configured to distribute air around its periphery 16 and is ejected at high speed and pressure to create a momentum curtain of air. The air is directed slightly inward, and trapped above and below between the hover cell and the ground, and by the momentum curtain laterally, it creates the air cushion which at least partly supports the vehicle.

Optionally, hover plenums may also be placed in the vertical slot directly below the jet engine, oriented vertically as may be seen in FIG. 3. As the only outlet for air is directly downwards through the narrow opening in the chassis 17, 18, a cushion of air is created centrally, between the two horizontally disposed hover plenums 13.

An alternative embodiment comprising an electric linear induction motor as a forward propulsion engine is shown schematically in FIGS. 5-7. The motor 30 is centrally disposed above the chassis 32 which defines a central rail slot. This embodiment is a track-guided rail vehicle, intended to be entirely air supported when in forward motion. The components of this embodiment may be identical or similar to those described above in connection with the use of a jet engine.

The forced air (compression) inlet 34 is located facing forward to take advantage of high-pressure zones created by high forward speed. The incoming air passes directly over the linear induction motor coils 36 within the induction motor casing 30, where heat exchange takes place, and into the forced air duct 38, leading to the compressor plenum 40.

The compressor 42 may be a centrifugal fan, as described above. The compressor 42 output is directed into a compressed air duct 44, leading to hover cells 46, which may be configured as described above.

The system thus implemented may have the advantage of a higher efficiency as waste heat from one process is used to reduce the mechanical energy required for the compressor/air cushion process. Scalability and efficiency of such a system is limited only by the size of the vehicle in which it is integrated.

Interpretation. Any term or expression not expressly defined herein shall have its commonly accepted definition understood by a person skilled in the art.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. An air cushion system for a vehicle, the vehicle comprising a forward propulsion engine, the system comprising:
a) an air intake located in a high pressure zone created by forward movement of the vehicle;
b) an air cushion compressor; and
c) a heat exchanger associated with the forward propulsion engine, disposed between the air intake and the air cushion compressor, to heat the air prior to being compressed by the air cushion compressor.

2. The system of claim 1, wherein the forward propulsion engine is a linear induction motor or an internal combustion engine.

3. The system of claim 2 wherein the forward propulsion engine is a linear induction motor.

4. The system of claim 2 wherein the forward propulsion engine is an internal combustion engine.

5. The system of 4 wherein the forward propulsion engine is a jet engine.

6. The system of claim 1, wherein the vehicle is entirely air cushion supported at high speed.

7. A method of forming an air cushion under a high-speed vehicle, comprising the steps of:
a) drawing in air from an air intake located in a high pressure zone created by forward movement of the vehicle;
b) heating the air with heat from a forward propulsion engine and passing the heated air to an air cushion compressor; and
c) forming an air cushion under the vehicle with the air cushion compressor.

8. The method of claim 7 wherein the forward propulsion engine is a linear induction motor or an internal combustion engine.

9. The method of claim 8 wherein the forward propulsion engine is a linear induction motor.

10. The method of claim 8 wherein the forward propulsion engine is an internal combustion engine.

11. The system of claim 10 wherein the forward propulsion engine is a jet engine.
